(19) United States
(12) Patent Application Publication
(10) Pub. No.: US 2012/0009305 A1
(43) Pub. Date: Jan. 12, 2012

(54) COMPOSITE FILMS FOR PACKAGING FRESH RED MEAT AND FISH

(75) Inventors: Karlheinz Hausmann, Auvernier (CH); Silvia Schleidt, Geneve (CH); Marc Goyvaerts, Rijmenam (BE); Hubert Verhaag, Kevelaer (DE)

(73) Assignee: E. I. DU PONT DE NEMOURS AND COMPANY, Wilmington, DE (US)

(21) Appl. No.: 13/150,298

(22) Filed: Jun. 1, 2011

Related U.S. Application Data
(60) Provisional application No. 61/363,014, filed on Jul. 9, 2010.

(51) Int. Cl. A23B 4/16; B65B 25/00

(52) U.S. Cl. 426/125; 426/263

(57) ABSTRACT

Disclosed are a composite film, and use of the film, in which the film has an oxygen permeation rate of from about 50 to about 2000 cm³×mil/[m²×day] and comprises or is produced from at least one sealant layer and at least one barrier layer for packaging fresh meat or fish product. The sealant layer comprises an ethylene or ethylene copolymer that contacts the fresh meat or fish product which has been pretreated in an oxygen atmosphere having a pressure of about 6 to about 20 bar (6×10⁵ to 2×10⁶ Pascals).

The application claims priority to U.S. provisional application No. 61/363.014, filed Jul. 9, 2010; the entire disclosure of which is incorporated herein by reference.

### FIELD OF THE INVENTION

The present invention relates to the use of films comprising ethylene copolymers for packaging of fresh meat and fish pretreated in an oxygen atmosphere.

### BACKGROUND OF THE INVENTION

In the packaging arts, especially in the meat packaging arts, there are numerous solutions to packaging red meat such as for example beef or tuna.

A particular packaging solution, the vacuum skin pack (VSP), is very popular in supermarkets, because it can be displayed in a hanging vertical position in the shelves and because of its low bulk volume in comparison with more traditional tray packaging. VSPs for meat and fish products consist of a bottom tray and an oxygen impermeable top film covering the meat and fish products and the tray.

However, a problem with VSPs is that meat and fish products, particularly red meat and fish products, turns from bright red to purple or brown color when packaged into a VSP after a relatively short period of time. The reason for this color change is that the applied vacuum converts an oxygen-binding meat protein, called oxymyoglobin (red), into an oxygen-free state called deoxymyoglobin (purple). The oxygen-free deoxymyoglobin can be further degraded in an oxidative reaction. This reaction yields metmyoglobin (brown) in which the heme iron Fe²⁺ is oxidized into Fe³⁺. The oxidized Fe³⁺ cannot bind oxygen, but instead binds a water molecule.

This color change dramatically reduces the shelf appeal of the meat and fish products, because consumers prefer bright red meat and fish products displaying a so-called red “bloom” generated by oxymyoglobin instead of the darker purple color of deoxymyoglobin.

Because the binding of oxygen in oxymyoglobin and deoxymyoglobin is reversible, the color change is also reversible.

In fact, after the consumer opens the VSP package, the meat reverts back to a bright red “bloom” as it comes into contact again with atmospheric oxygen. However, at the time of purchase, the meat may have had an undesirable and unattractive purple color if packed in an oxygen impermeable VSP.

For this reason, other packaging solutions have been developed, such as the modified atmosphere packaging, known as MAP.

In a MAP, the meat is not vacuum packed, but is instead placed into a large tray containing a modified atmosphere and having an oxygen impermeable top lid. The modified atmosphere usually consists of an oxygen-rich gas mixture or a carbon monoxide-rich gas mixture that effectively preserves the bright red color of the meat.

However, MAPs suffer from a series of disadvantages.

As a consequence of accommodating a sufficient amount of gas, the MAPs are very bulky. Furthermore, the MAPs must always be stored in a horizontal position, because the meat is not fixed in the package and should not touch the lidding film of the package in order to avoid discoloration. Last but not least, meat packed in a MAP will exude significant amounts of blood and/or juice, the so-called “purge”. This juice gives an unattractive presentation to the meat, and in most cases, a liquid absorbing cloth is placed underneath the meat to prevent the juice from spreading in the package. However, the liquid absorbing cloth adds to the overall cost of the package and may also provide a breeding ground for pathogens.

Improvements that remedy some of the disadvantages of a MAP have been proposed. For example, it has been proposed to additionally skin package the meat with a low-barrier film inside the MAP. This enables the enhanced package to be displayed vertically, because the meat is now fixed to the tray via the skin package. However, this solution is more costly and is perceived by customers as being heavily “overpackaged”.

Recently, efforts have been made to process red meats in a way that permits a longer shelf life and a longer retention of the bright red color. Such a method is described in European Patent No. 1014800, in which the meat is exposed to high pressure oxygen to saturate the meat in-depth with oxygen-carrying oxymyoglobin. This process allows for the meat to retain the bright red “bloom” for extended periods, even when stored in an unmodified atmosphere.

Surprisingly, if meat treated according to EP1014800 is packed into a conventional VSP, it quickly turns brown because of metmyoglobin formation, despite the fact that it was pretreated with high pressure oxygen.

Intuitively, the expectation is that the pretreated meat would remain bright red, because the oxygen in the meat would remain trapped in the packaging, since conventional VSPs have an oxygen impermeable top film.

However, the meat quickly turns brown in conventional oxygen impermeable VSPs having an oxygen transmission rate (OTR) of less than about 3 cm³/[m²×day].

Replacing the oxygen impermeable top film with a “breathable” top film having an OTR of more than 5000 cm³/[m²×day] does not solve the problem either, and the meat quickly turns brown as well, as it would when stored in an unpackaged state.

Therefore, there is a strong felt need to provide a packaging that maintains the bright red meat “bloom” for extended periods of time in the case the meat has been pretreated by oxygen.

### SUMMARY OF THE INVENTION

The invention provides a composite film, and use of the film, in which the film has an oxygen permeation rate of from about 50 to about 2000 cm³×mil/[m²×day] and comprises or is produced from at least one sealant layer and at least one barrier layer for packaging fresh meat or fish product. The sealant layer comprises an ethylene or ethylene copolymer that contacts the fresh meat or fish product which has been pretreated in an oxygen atmosphere having a pressure of about 6 to about 20 bar (6×10⁵ to 2×10⁶ Pascal).

The invention further provides a packaging comprising a composite film having an oxygen permeation rate of from about 50 to about 2000 cm³×mil/[m²×day], comprising at least a sealant layer and a barrier layer and at least one meat or other product.

### DETAILED DESCRIPTION OF THE INVENTION

All tradenames or trademarks are in upper cases. The words following the verb “is” are definition.

Oxygen permeability and transmission rates are measured according to the ASTM-3985 on a MOCON OX-TRAN® Model 2/61 at 50% RH (relative humidity) and 23° C., unless described otherwise.

The composite film comprises or is produced from a barrier layer and a sealant layer. The sealant layer is in contact with meat or other product.

The barrier layer can function as a selective membrane that determines the degree to which a certain fluid (gas, vapor, or liquid) permeates through the barrier layer. The barrier layer has an oxygen permeation rate of from about 50 to about 2000, preferably 100 to 1000 cm³×mil/[m²×day].

The barrier layer can be any suitable polymer, such as for example, but not limited to, polyolefins, polyamides, polyesters, polysaccharides, ethylene vinyl alcohol copolymers (EVOH), or combinations of two or more thereof.

The polymer of the barrier layer and the sealant layer can be sourced from renewable (i.e. not petrochemical) sources. For example, ethylene monomer can be obtained from wheat, corn or sugarcane ethanol which can be produced by fermentation and wherein the ethanol is subsequently subjected to dehydration. Likewise, diamines, diacids, diols such as 1,3-propane diol, hydroxylated acids, and/or polyhydroxy alkanoates, may also be isolated from renewable sources such as castor bean oil, lactic acid, starch, sugar, and the like.

Polyolefins include polyethylene, polypropylene, ethylene/propylene copolymer, polyvinylchloride, or combinations of two or more thereof.

Polyethylene can be prepared by a variety of methods, including well-known Ziegler-Natta catalyst polymerization (e.g., U.S. Pat. No. 4,076,698 and 3,645,992), metallocene catalyst polymerization (e.g., U.S. Pat. No. 5,198,401 and 5,405,922), and by free radical polymerization. Polyethylene can include linear polyethylenes such as high density polyethylene (HDPE), linear low density polyethylene (LLDPE), very low or ultralow density polyethylenes (VLDPE or ULDPE), branched polyethylenes such as low density polyethylene (LDPE), and metallocene-catalyzed polyethylene (mPE). The densities of polyethylenes suitable for use range from 0.865 g/cc to 0.970 g/cc.

Polypropylene includes propylene homopolymers, impact modified polypropylene and copolymers of propylene and alpha-olefins and their blends.

Polyamides are produced from lactams or amino acids (e.g. nylon-6 or nylon-11) or from condensation of diamines such as hexamethylene diamine with dibasic acids such as succinic, adipic, or sebacic acid. Copolymers and terpolymers of these polyamides are also included. Polyamide layer may also include one or more polyamide nanocomposites such as those available commercially under the tradename AEGIS™ from Honeywell or IMPERM™ MXD6 from Mitsubishi Gas Chemicals/Nanocor. Nanocomposites are well known to one skilled in the art and are commercially available. Preferred polyamides useful include polyepsiloncaprolactam (nylon-6 or PA6), polyhexamethylene adipamide (nylon-6,6 or PA66), PA10, PA11; PA12, PA34, 46, PA6, PA66, PA6/66, PA612, PA6T, PA6I/6T, or combinations of two or more thereof. Most preferably, the polymer can be PA6, PA6/66, PA6T, PA6I/6T, or combinations of two or more thereof.

Polyester includes, for example, semiaromatic polyesters such as polyethylene terephthalate (PET), polypropylene terephthalate (PPT), polybutylene terephthalate (PBT), polytrimethylene terephthalate (PTT), and aliphatic polyesters such as polylactic acid (PLA), and tougheners (for example PBT and/or PET blends).

The term “copolymer of PET” means any polymer comprising (or derived from) at least about 50 mole % PET and the remainder being derived from monomers other than terephthalic acid and ethylene glycol (or their ester forming equivalents). Other comonomers include for example diacids such as succinic acid, adipic acid, azelaic acid, sebacic acid, glutaric acid 1,10-decanedicarboxylic acid, phthalic acid, isophthalic acid, dodecanedioic acid, and the like; and ester forming equivalents thereof, diols such as propylene glycol, methoxypolyalkylene glycol, neopentyl glycol, trimethylene glycol, tetramethylene glycol, hexamethylene glycol, diethylene glycol, polyethylene glycol, cyclohexane dimethanol, and the like.

Polysaccharide can include natural carbohydrates including, but not limited to, cellulose, hemicellulose, hydroxycellulose, starch, hyaluronic acid, chondroitin, peptidoglycan, murein, pectin, ligin, agar, alginic acid, gum Arabic, extensin, xanthan, or combinations of two or more thereof. For example, cellulose (e.g., paper) layer can be any type of paper typically used in the packaging industry, flexible or semi-flexible, and having a weight between 20 and 400 g/m². This weight governs the degree of flexibility of the paper. Paper, being a very porous material, does not control the oxygen or water vapor barrier properties of the packaging material.

EVOH also includes saponified or hydrolyzed ethylene vinyl acetate copolymers having from 27 to 44 mole % ethylene and can be prepared by, for example, hydrolysis of vinyl acetate copolymers, or by chemical reactions with polyvinyl alcohol. The degree of hydrolysis can range from about 50 to about 100, or about 85 to about 100, mole %. EVOH is available from Kuraray under the trademark NOLTEX® from Nippon Goshei.

The barrier layer can also be a multilayer layer where each layer contains one or more of the above-disclosed polymers. Multiple layers of polymeric material can be combined into a multilayer barrier layer, with the proviso that the combined layers have an oxygen permeation rate of from about 50 to about 2000, more preferably 100 to 1000 cm³×mil/[m²×day].

The sealant layer functions as a membrane that contacts the meat and other product and can be sealed to either itself to form a pouch or to another substrate to form a tray. For this, the sealant layer can be heated up to a temperature of at least the melting temperature thereof by methods known in the art such as sealing bars, irradiation and others.

The sealant layer can be of any suitable polymeric material, such as for example, but not limited to, polyolefins, polyamides, polyesters, polysaccharides and/or combinations thereof. These are the same as barrier layer. In the case where the barrier layer and the sealant layer are the same, the barrier layer and sealant layer may be present as one monolithic layer or as two discrete layers, optionally bound together by a tie layer.

Sealant layer, also referred to as sealing layer, heat-seal layer, or seal layer, is an outer film layer, or layers, involved in the sealing of a film to itself, another film layer of the same or another film, and/or another article that is not a film. Up to the outer 3 mils of a film can be involved in the sealing of the film to itself or another layer. As to packages having only fin-type seals, as opposed to lap-type seals, sealant layer refers to the inside film layer of a package, as well as supporting layers within 3 mils of the inside surface of the sealant layer, the inside layer frequently also serving as a food contact layer in the packaging of foods. Sealant layers employed in the packaging art include thermoplastic polymers. Such polymers have a melt index of preferably less than 30 g/10 min and more preferably less than 20 g/10 min, having a glass transition temperature of less than 100° C. in order to allow easy sealing performance.

Preferred sealant layer can be chosen among polyolefins such as ethylene polymers or ethylene copolymers. Ethylene polymers include, but are not limited to, those polyethylenes disclosed above such as HDPE, mPE, LLDPE, LDPE, ULDPE, or combinations of two or more thereof. Also included are ethylene propylene diene monomer (EPDM), ethylene propylene copolymer, and/or combinations thereof. Preferably, the ethylene polymers are chosen among ULDPE, LDPE, LLDPE and/or combinations thereof and more preferably, the ethylene polymer is mPE.

Metallocene-catalyzed PE (mPE) is a copolymer of ethylene and α-olefins and has high flexibility and low crystallinity.

Ethylene copolymers having small amounts of a diolefin component such as butadiene, norbornadiene, hexadiene and isoprene are also generally suitable.

Ethylene copolymer can include ethylene vinyl acetate copolymer (EVA), ethylene α,β-unsaturated C₃-C₈ carboxylic acid copolymer (acid copolymer), ethylene α,β-unsaturated C₃-C₈ carboxylic acid copolymers partially neutralized with metal ions (ionomer), and/or combinations of two or more thereof.

EVA comprises repeat units derived from ethylene and vinyl acetate. Preferably the amount of ethylene is at least about 45 or 82 weight %, by weight of the copolymer and the amount of vinyl acetate is at least about 18 or 55 weight %, by weight of the copolymer. EVA can also be a terpolymer made from ethylene, vinyl acetate and carbon monoxide. EVA is available as ELVAX® from E. I. du Pont de Nemours and Company, Wilmington, Del. (DuPont).

The acid copolymer can include a copolymer comprising repeat units derived from ethylene and an α,β-unsaturated C₃-C₈ carboxylic acid including alky (meth)acrylic acid, maleic acid, fumaric acid, itaconic acid, or combinations of two or more thereof where (meth)acrylic acid includes acrylic acid, methacrylic acid, or both. The acid copolymer can also include a third comonomer such as alkyl (meth)acrylate, glycidyl (meth)acrylate, carbon monoxide, or combinations of two more thereof where the alkyl can contain 0 to about 5 carbon atoms and (meth)acrylate includes acrylate and methacrylate. Preferred α,β-unsaturated C₃-C₈ carboxylic acids are acrylic acid and methacrylic acid. An acid copolymer is well known to one skilled in the art such as NUCREL® commercially available from DuPont.

A preferred ionomer can be one derived from ethylene α,β-unsaturated C₃-C₈ carboxylic acid copolymer by partially neutralizing the acid copolymer with metal ions. The acid copolymer can be the same as that disclosed above. The unsaturated carboxylic acid can be present in at least about 2 weight %, based on the total weight of the ionomer. Preferably, the unsaturated carboxylic acid is present from about 2 to about 30 weight % or from about 9 to about 19 weight %. When the weight % of the unsaturated carboxylic acid is in excess of about 15, based on the total weight of the polymeric material, a reduction of the so-called “purge” can be observed if the packaged meat and fish product is subjected to a heat treatment called secondary sealing at a temperature between the VICAT temperature and the melting temperature of the sealant layer for 0.5-5 seconds. This considerably increases the attractiveness of the packaged meat and fish products to the prospective buyer, because the absence of exuded blood and/or juice is perceived as an indicator of freshness. A process to reduce purge is described in European patent No. 1092532.

Neutralization of an ethylene acid copolymer can be effected by first making the ethylene acid copolymer and treating the copolymer with inorganic base(s) with alkali metal, alkaline earth metal or transition metal cation(s). For example, the acid copolymer can be partially neutralized with metal ions of the group I or group II of the periodic table of the elements. The preferred metal ions are sodium, zinc, lithium, magnesium or calcium, or combinations of any of these. More preferred are zinc, calcium and magnesium. Most preferably, the metal ion is zinc. The total percent neutralization of the acid copolymer can be from about 1 to 99%, 10 to 70%, or 35 to 70%. Methods for preparing ionomers from copolymers are well known in the art.

The ionomer can optionally comprise softening comonomers that reduce the crystallinity of the copolymer such as alkyl acrylates and alkyl methacrylates including butyl acrylate, n-butyl acrylate, iso-butyl acrylate, n-butyl methacrylate, methyl methacrylate, or combinations of two or more thereof. The softening comonomers can be present in up to 30 weight %, up to 15 weight %, or up to 5 weight %, based on the total weight of the polymeric material.

Preferably, the ionomer does not contain repeat unites derived from a softening comonomer and is a dipolymer of ethylene and an α,β-unsaturated C₃-C₈ carboxylic acid.

The sealant layer can be either a monolayer or a multilayer containing one or more layers produced from one or more of the polymers disclosed above. The sealant layer can have a thickness of from about 5 to 50 μm or about 10 to 20 μm.

The composition of the sealant layer can be chosen in a way that the seal resulting from sealing of the sealant layer to itself or another substrate by heating is a peelable seal. A peelable seals refers to a seal has a seal strength of less than 15 N/mm, preferably of from 3 to 15 N/15 mm, when tested according to standard methods. Peelable seals can be obtained according to US2005266257 by blending the ethylene copolymer of the sealant layer with propylene/α-olefin copolymers wherein the including α-olefin can be chosen among ethylene, butene, or combinations thereof.

The composite film may further comprise a tie layer comprising a polyolefin, such as, for example, ethylene polymer, an ethylene α,β-acid copolymer disclosed above, an ethylene acrylate copolymer, ethylene vinyl alcohol copolymer, or combinations of two or more thereof. These polymers can be optionally grafted with an anhydride of unsaturated dicarboxylic acids such as maleic anhydride, fumaric anhydride, itaconic anhydride, or combinations of two or more thereof.

The tie layer is an acid copolymer disclosed above.

The composite film can have an oxygen permeation rate of from about 50 to 2000 cm³×mil/[m²×day], as measured according to the ASTM-3985 on a MOCON OX-TRAN® Model 2/61 at 50% RH and 23° C. The oxygen transmission rate (OTR) can be obtained by dividing the oxygen permeation rate by the thickness of the composite film. Such oxygen permeation rates exclude oxygen impermeable barrier layers such as EVOH, since they have oxygen permeation rates lower than 10 cm³×mil/[m²×day].

When the oxygen permeation rate of from about 50 to 2000 cm³×mil/[m²×day] is achieved in the composite film the red bright “bloom” of the fresh meat or fish product or other product such as fish that has been pretreated with high pressure oxygen can be maintained over extended periods of time between 5 to 30 or 10 to 20 days, even when packed under vacuum.

The meat and fish products or other product is pretreated prior to packaging is a process in which the meat is exposed to an oxygen atmosphere having a pressure of about 6 to about 20 bar for a given time. The meat can be placed in an airtight chamber which is then pressurized with oxygen for an extended time period during which the meat is completely permeated by oxygen. The temperature and inflow/outflow of oxygen are controlled in such a way that the meat and fish products or other product does not freeze during the process. This process enables the meat and fish products to retain the desired bright red “bloom”, even when stored for periods of 4 to 5 days under atmospheric pressure, like for example, in an open supermarket meat and fish products counter (Offenverkauf, or over the counter sale). The process has been thoroughly described in EP1014800 (equivalent to U.S. Pat. No. 6,716,464(B1)), the disclosures of the EP and US patents are incorporated herewith by reference. However, packaging said pretreated meat in conventional vacuum skin packs (VSPs) while preserving the “bloom” is surprisingly difficult. Meat and fish products packaged in common VSPs having a high oxygen barrier layer of only EVOH turns brown within 1-2 days even when stored at low temperatures such as 2-3° C., which is surprisingly even faster than unpretreated meat and fish products.

The composite film or a portion thereof resolves the problem of browning of the pretreated meat and fish products in a VSP.

The composite films can be prepared by conventional methods known in the art, including, but not limited to, extrusion, co-extrusion, or co-extrusion followed by lamination of one or more layers onto a previously co-extruded layer or heat lamination. Suitable extrusion techniques include blown film extrusion, cast film extrusion, cast sheet extrusion, extrusion coating, double bubble co-extrusion and tandem extrusion. Preferably, the composite film is a blown film obtained by blown film extrusion.

Individual polymer of the composite film or the composite film can further comprise 0.001 to about 30%, based on the weight of the film, one or more additives, such as UV filters (stabilizers), thermal stabilizers, colorants, pigments and dyes, fillers, delustrants, antioxidants, anti-slip agents, antiblock agents, chill roll release agents, compatibilizers, components for modifying surface characteristics such as Coefficient of Friction (COF), anti static, or anti-fog agents, other processing aids. It has been known in the art that formation of metmyoglobin is accelerated by exposure to UV light and/or light from fluorescent lamps. By adding UV light filters to the composite film, a product such as meat and fish products can be exposed to less radiation and the formation of metmyoglobin can be reduced, which in turn can lead to longer retention of the red bright “bloom”.

The invention also provides an article or package comprising the composite film. The package can include container, blister pack, or pouch. For example, a single sheet of the composite film can be folded back on itself and sealed along essentially three sides, or the superimposed edges, directly or indirectly through a third intervening polymer film thereby defining a sealed perimeter and forming a pouch. Alternatively, a multi-sheet comprising one first sheet of the composite film and a second sheet of polymer film (which can be the same as, or different from, the composite film) can be sealed to each other directly or indirectly through a third intervening polymeric film thereby defining a sealed perimeter and forming a pouch. For example, packages can be prepared from two webs of the composite film. After placing the contents of the package between the film webs and applying a vacuum, the package is formed by adhering, preferably by heat sealing, the perimeters of the two webs to each other. The heat sealed perimeter of the package can be achieved by superimposing the first and second webs of polymeric film and then heat sealing each directly to the other or heat sealing them indirectly through the use of an intervening third polymeric film, again as generally known and practiced in the art

The composite film can also be coated on, laminated with, attached to, or wrapped with, a rigid or semi-rigid substrate or a tray.

The substrate or tray may be of any material that is known in the packaging arts, such as paper, paper board, nonwoven material, woven material, metal foil, plastic, wood, stone, particle board, chip board, oriented strand board, plywood, fiber, fiber board, foamed material, plastic film, cloth, or combinations of two or more thereof.

The article or package comprising film may in the form of a smaller portion package, cook-in package, retortable package, formed package, shrink film package, shrinkable bag, green package, direct to freezer package, zippered pouch package. A substrate or tray having an oxygen permeability rate of the substrate or tray from about 50 to 2000 cm³×mil/[m²×day] can ensure that the pretreated meat and fish products retain the red bright “bloom”, even on surfaces that are not visible to the prospective customer at the time of purchase, but will be upon opening of the package.

In the case where the substrate or tray is a plastic film, the film may be single-layered or multilayered and may be oriented or unoriented. The plastic film may be any suitable polymeric material, such as for example, but not limited to, polyolefins, polyamides, polyesters, polysaccharides and/or combinations thereof.

To fulfill the requirement of the oxygen permeation rate from about 50 to 2000 cm³×mil/[m²×day], it is therefore possible to use a substrate or tray having an oxygen permeation rate in excess of 2000 cm³×mil/[m²×day] and to combine it with multilayer film.

The film or multilayer film of the substrate or tray may therefore form the least oxygen permeable layer in the substrate or tray. Therefore combining a highly permeable substrate or tray, such as for example cardboard, with the multilayer film may yield a substrate or tray having the required oxygen permeation rate from about 50 to 2000 cm³×mil/[m²×day].

Combining the composite film with the substrate or tray can be done by means known in the art such as, but not limited to, calendaring, laminating, gluing, clinging, coextruding, and/or combinations thereof.

The substrate or tray may be printed, colored or otherwise decorated.

A process for producing a package, which comprises fresh product (e.g., fresh meat of fish product), comprises preparing or producing a composite film; converting the film to a container; treating fresh meat or fish with oxygen or oxygen-rich air to produce pretreated product; placing the pretreated product into the container; and vacuum skin packaging (VSP) the container. The fresh product can optionally be frozen before or after the packaging process.

Any fresh meat or fish product desirable to be kept fresh-look color can be used in the process. The meat product can be any meat including beef, pork, veal, lamb, game, poultry, horsemeat, raw sausage, ham, or any other animal meat. Similarly, any fish product can be used. In certain instances, vegetables can also be so packaged.

The composite film and its production can be the same as disclosed above. Similarly, its conversion to a container such as pouch or its coating onto, laminated to, or attached to, a substrate or tray is also as disclosed above.

Pretreatment with oxygen or oxygen-enriched air can be carried out by any means known to one skilled in the art. For example, product to be packaged (fresh meat as example here) is stored for a presettable time at a superatmospheric pressure in an air-tightly scalable space after supply of oxygen. During the supply of the oxygen, its temperature is selected such that, and the feed rate is set or controlled to be low enough that, the fresh meat does not freeze, in that the pressure during the storage is selected to be high enough, and the storage time long enough, so that the fresh meat is completely penetrated by oxygen, and in that, during removal of the oxygen, a removal rate is set or controlled to be low enough that, firstly, the fresh meat does not freeze and, secondly, the oxygen permeating the treated fresh meat is removed from the fresh meat without bubble formation. Such process is as disclosed above in EP1014800, or U.S. Pat. No. 6,716,464(B1), the disclosure of each is incorporated herein by reference.

VSP is well known to one skilled in the art such as briefly disclosed above. For example, the pre-treated fresh product can be sealed into conventional vacuum packages after completion of the treatment and then to freeze it or first to freeze it then to seal it into vacuum packages. Because VCP is well known to one skilled in the art, the description of which is omitted herein for the interest of brevity.

1. A package comprising or produced from a composite film wherein
the fresh meat or fish product has been pretreated in an oxygen atmosphere having a pressure of about 6 to about 20 bar (6×10⁶ to 2×10⁶ Pascals);
the film comprises or is produced from a sealant layer and a barrier layer;
the sealant layer is in contact with the fresh meat or fish product; and
the film has an oxygen permeation rate of from about 50 to about 2000 cm³×mil/[m²×day].

2. The package of claim 1 further comprising fresh meat or fish product wrapped in the film wherein the fresh meat or fish product has been pretreated in an oxygen atmosphere having a pressure of about 6 to about 20 bar.

3. The package of claim 2 wherein the sealant layer comprises or is ethylene copolymer.

4. The package of claim 3 wherein the sealant layer is an ethylene acid copolymer or an ionomer; the acid copolymer is an ethylene α,β-unsaturated C₃-C₈ carboxylic acid copolymer having at least 2 weight percent of repeat units derived from the C₃-C₈ carboxylic acid; and the ionomer is derived from the acid copolymer.

5. The package of claim 4 wherein the ionomer is derived from the acid copolymer by partially neutralization of the acid copolymer with metal ions and metal ion is selected from the group consisting of Zn, Ca, Mg, and combinations of two or more thereof.

6. The package of claim 4 wherein the barrier layer comprises or is a polyamide selected from the group consisting of PA34, 46, PA6, PA66, PA6/66, PA10, PA612, PA6T, PA6I/6T, PA12, and combinations of two or more thereof.

7. The package of claim 5 wherein the barrier layer comprises or is a polyamide selected from the group consisting of PA34, 46, PA6, PA66, PA6/66, PA10, PA612, PA6T, PA6I/6T, PA12, and combinations of two or more thereof.

8. The package of claim 6 wherein the film further comprises a tie layer comprising a polyolefin.

9. The package of claim 8 wherein the polyolefin is grafted with an anhydride of an unsaturated dicarboxylic acid.

10. The package of claim 7 wherein the film further comprises a tie layer comprising a polyolefin.

11. The package of claim 10 wherein the polyolefin is grafted with an anhydride of an unsaturated dicarboxylic acid.

12. The package of claim 4 wherein the film further comprises a rigid or semi-rigid substrate or a tray and the substrate or tray has coated thereon, laminated therewith, attached thereto, or wrapped therewith, the film.

13. The package of claim 6 wherein the film further comprises a rigid or semi-rigid substrate or a tray and the substrate or tray has coated thereon, laminated therewith, attached thereto, or wrapped therewith, the film.

14. The package of claim 13 wherein the film further comprises a tie layer comprising a polyolefin, which is optionally grafted with an anhydride of an unsaturated dicarboxylic acid.

15. The package of claim 7 wherein the film further comprises a rigid or semi-rigid substrate or a tray and the substrate or tray has coated thereon, laminated therewith, attached thereto, or wrapped therewith, the film.

16. The package of claim 15 wherein the film further comprises a tie layer comprising a polyolefin, which is optionally grafted with an anhydride of an unsaturated dicarboxylic acid.

17. The package of claim 14 wherein the film has an oxygen permeation rate of from about 100 to about 1000 cm³×mil/[m²×day].

18. The package of claim 16 wherein the film has an oxygen permeation rate of from about 100 to about 1000 cm³×mil/[m²×day].

19. A process for producing a package, comprising producing a composite film; converting the film to a container; treating fresh meat or fish with oxygen or oxygen-rich air under a condition that the meat or fish does not freeze; removing the oxygen or oxygen-rich air under a condition substantially controlling bubble formation to produce pretreated product; placing the pretreated product into the container; and vacuum skin packaging the container wherein the film is as recited in claim 1.

20. The process of claim 19 wherein the film has an oxygen permeation rate of about 100 to about 1000 cm³×mil/[m²×day].
